(19) United States
(12) Patent Application Publication
(10) Pub. No.: US 2011/0103253 A1
(43) Pub. Date: May 5, 2011

(54) METHOD AND APPARATUS FOR PROVIDING POWER SAVING USING SUPERFRAMES

(75) Inventors: Xin Qi, Beijing (CN); Andrea Bacioccola, Helsinki (FI); Zexian Li, Espoo (FI); Shashikant Maheshwari, Irving, TX (US)

(73) Assignee: NOKIA CORPORATION, Espoo (FI)

(21) Appl. No.: 12/990,173

(22) PCT Filed: Apr. 28, 2008
(86) PCT No.: PCT/IB2008/001054

§ 371 Date: Nov. 12, 2010

(51) Int. Cl. H04L 12/26; H04W 4/00

(52) U.S. Cl. 370/252; 370/328

(57) ABSTRACT

An approach is provided for providing sleep mode associated with a resource frame structure. A superframe that includes a plurality of frames that is partitioned into sub-frames is detected. A length of listening window (115) is determined based on the number of frames. A sleep window (117) is determined based on the superframe and the sleep window length specifies duration of an inactive mode of operation and the listening window (115) specifies duration of an active mode of operation.

### BACKGROUND

Radio communication systems, such as wireless data networks (e.g., WiMAX (Worldwide Interoperability for Microwave Access) systems, DVB (Digital Video Broadcasting)-H (Handheld) systems, and spread spectrum systems (such as Code Division Multiple Access (CDMA) networks), Time Division Multiple Access (TDMA) networks, etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves optimizing transmission of data in a manner that accounts for conservation of system resources—e.g., bandwidth, and power of the terminal.

### SOME EXEMPLARY EMBODIMENTS

There is therefore a need for an approach for providing reduced power consumption by mobile devices.

According to one embodiment of the invention, a method comprises detecting a superframe that includes a plurality of frames, wherein each of the frames is partitioned into sub-frames. The method also comprises determining length of a listening window based on the number of frames. The method also comprises determining length of a sleep window based on the superframe. The sleep window length specifies duration of an inactive mode of operation, and the listening window specifies duration of an active mode of operation.

According to another embodiment of the invention, an apparatus comprises logic configured to detect a superframe that includes a plurality of frames. Each of the frames is partitioned into sub-frames and the logic is further configured to determine length of a listening window based on the number of frames, and to determine length of a sleep window based on the superframe. The sleep window length specifies duration of an inactive mode of operation, and the listening window specifies duration of an active mode of operation.

According to another embodiment of the invention, a method comprises generating a superframe that includes a plurality of frames. Each of the frames is partitioned into sub-frames. The superframe includes a sub-frame concatenation pattern relating to an awake state of terminal operation.

According to another embodiment of the invention, an apparatus comprises means for generating a superframe that includes a plurality of frames. Each of the frames is partitioned into sub-frames. The superframe includes a sub-frame concatenation pattern relating to an awake state of terminal operation.

According to another embodiment of the invention, a method comprises generating a superframe that includes a plurality of frames for transmission to a terminal. Each of the frames is partitioned into sub-frames. The method also comprises generating a management message that specifies a particular sub-frame carrying traffic during each frame of a listening window associated with an active mode of operation for the terminal.

According to yet an exemplary embodiment, an apparatus comprises means for generating a superframe that includes a plurality of frames for transmission to a terminal. Each of the frames is partitioned into sub-frames. The apparatus also comprises means for generating a management message that specifies a particular sub-frame carrying traffic during each frame of a listening window associated with an active mode of operation for the terminal.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIGS. 1A and 1B are diagrams of a communication system capable of providing power saving for a mobile station, according to an exemplary embodiment of the invention;

FIG. 2 is a diagram of a structure of a superframe that is used in the system of FIG. 1, according to an exemplary embodiment of the invention;

FIG. 3 is a flowchart of a process for determining lengths of a listening window and a sleep window, in accordance with an embodiment of the invention;

FIG. 4 is a diagram of a listening window, according to an exemplary embodiment of the invention;

FIG. 5 is a flowchart of a process for acquiring configuration information by examining the next listening window, in accordance with an embodiment of the invention;

FIGS. 6A and 6B are flowcharts of processes for acquiring configuration information by waking up based on the superframe header, in accordance with an embodiment of the invention;

FIG. 7 is a flowchart of a process for acquiring synchronization of a superframe, in accordance with an embodiment of the invention;

FIGS. 8A and 8B are flowcharts of processes for providing power saving based on sub-frame structure, in accordance with an embodiment of the invention;

FIG. 9 is a diagram of hardware that can be used to implement an embodiment of the invention; and

FIGS. 10A and 10B are diagrams of an exemplary WiMAX (Worldwide Interoperability for Microwave Access) architecture, in which the system of FIGS. 1A and 1B can operate, according to various exemplary embodiments of the invention.

### DESCRIPTION OF PREFERRED EMBODIMENT

An apparatus, method, and software for providing power saving within mobile devices are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to WiMAX (Worldwide Interoperability for Microwave Access) technology, it is recognized by one of ordinary skill in the art that the embodiments of the inventions have applicability to any type of communication services and equivalent technologies.

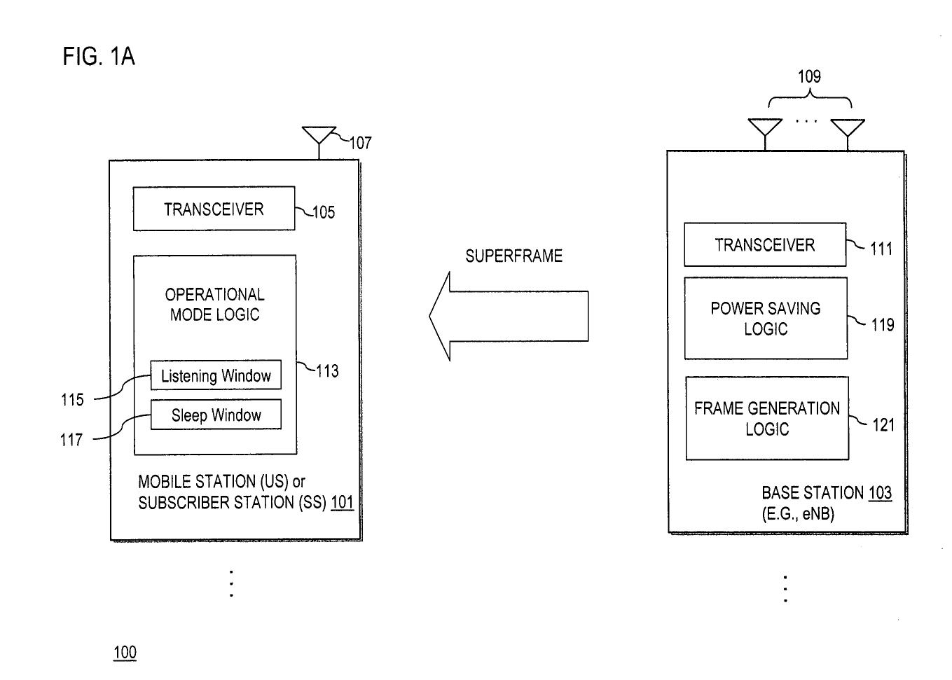

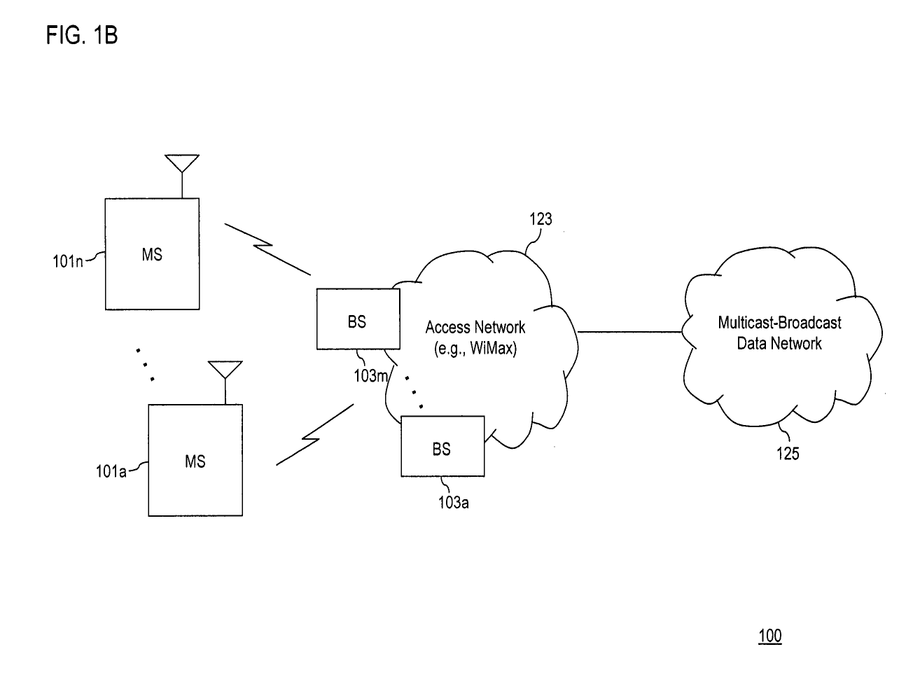

FIGS. 1A and 1B are diagrams of a communication system capable of providing power saving for a mobile station, according to an exemplary embodiment of the invention. A communication system 100, as seen in FIG. 1A, includes for one or more mobile stations (or subscriber stations) 101 and one or more base stations 103 for serving these subscriber stations 101. The subscriber stations 101 may be any type of mobile stations (MS) or user equipment, such as handsets, terminals, stations, units, devices, or any type of interface to the user (such as “wearable” circuitry, etc.). The MS 101 includes a transceiver 105 and an antenna system 107 that couples to the transceiver 105 to receive or transmit signals to the base station 103. The antenna system 107 can include one or more antennas (of which only one is shown). Accordingly, the base station 103 can employ one or more antennas 109 for transmitting and receiving electromagnetic signals. As with the MS 101, the base station 103 employs a transceiver 111, which transmits information over a downlink (DL) to the MS 101.

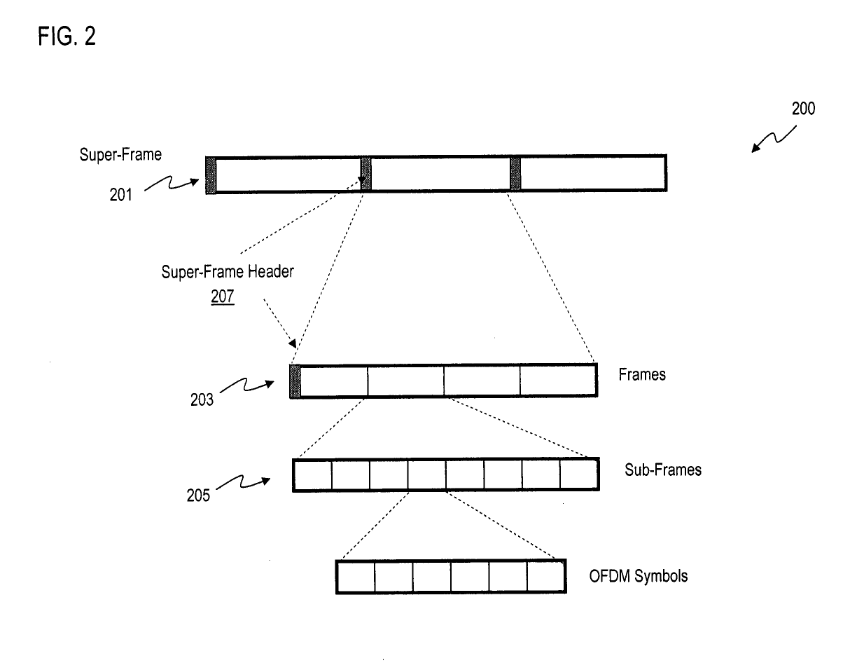

The system 100 provides enhanced power saving functionality to help reduce power consumption in the mobile stations 101 for the services and applications of the system 100. Accordingly, the mobile station 101 employs logic 113 to switch from an awake (or active) state to a sleep (or inactive, idle) state. In the sleep mode, the MS 101 is effectively absent with respect to the air interface of the serving base station 103; consequently, no air interface resources are utilized. These state transitions are triggered by a listening window 115 and a sleep window 117. The base station 103 includes a power saving logic 119 that can instruct the mobile station 101 to enter power saving mode—i.e., sleep mode via signaling of the sleep window. The power saving logic 119 can set the lengths of the listening window 115 and the sleep window 117, and interact with a frame generation logic 121 to implement the windows 115, 117 over various frame structures (as shown in FIG. 2).

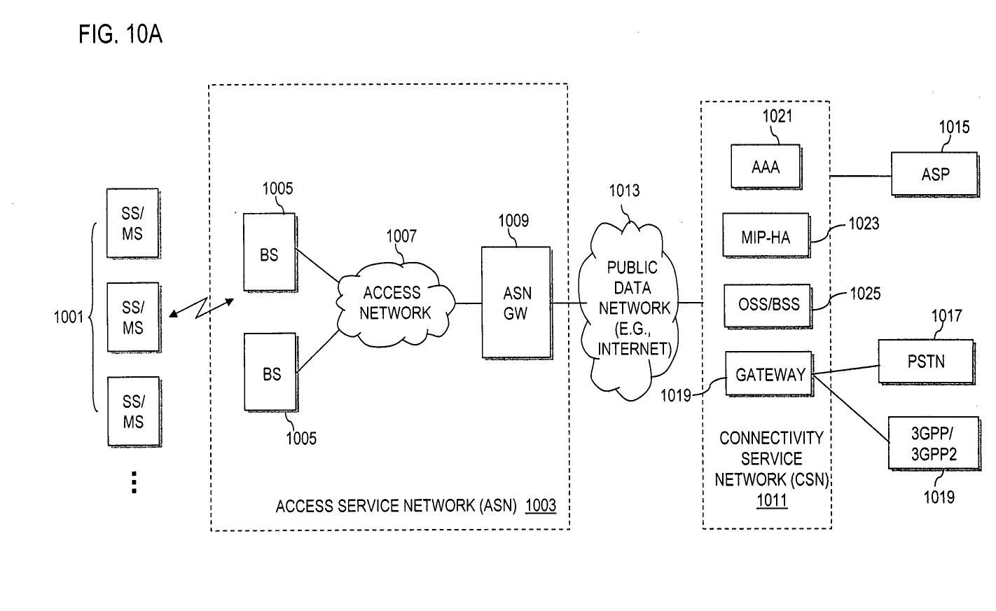

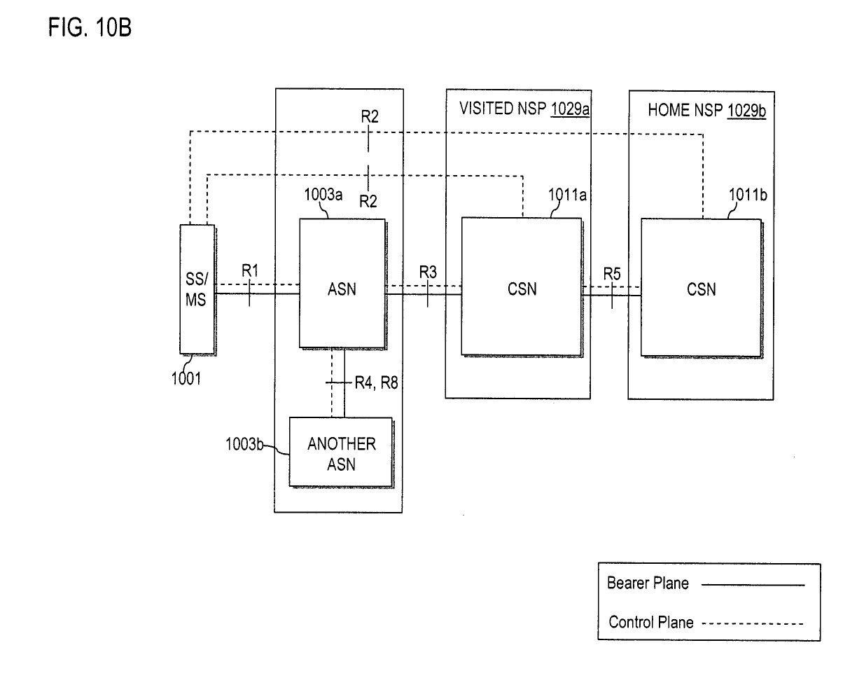

Per FIG. 1B, according to one embodiment, the base station 103 is part of an access network (e.g., 3GPP LTE (or E-UTRAN or 3.9G), WiMAX (Worldwide Interoperability for Microwave Access), etc.); such an access network 123 is further detailed in FIGS. 10A and 10B. The access network 123, which includes one or more base stations (BSs) 103a-103m configured to communicate with the mobile stations 101a-101n, provides WIMAX access services. As shown, the access network 123 communicates with a multicast-broadcast data network 125. WIMAX access services can include datacast services, such as packet-based television service or other audio or video streaming services. Multicast technology permit Internet Protocol televisions (IPTV) providers to selectively transmit packetized IPTV data wirelessly to targeted groups of subscribers rather than broadcasting (which can unnecessarily consume network resources). That is, multicasting is especially attractive from the point of view of the service provider precious bandwidth can be conserved.

In WiMAX, sleep mode (e.g., inactive mode or state) can minimize MS power usage as well as decrease usage of serving BS air interface resources. For each involved MS 101, the BS 103 can maintain one or several contexts for this operational mode, e.g., each one being related to a certain Power Saving Class (PSC). PSC is a group of connections that have common demand properties. By way of example, multiple types of PSCs are defined, and differ by their parameter sets, procedures of activation/deactivation, and policies of MS availability for data transmission.

FIG. 2 is a diagram of a structure of a superframe that is used in the system of FIG. 1, according to an exemplary embodiment of the invention. A high-level superframe/frame/sub-frame (SFS) structure 200 defines a superframe 201 that encompasses one or more frames 203—e.g., 4 frames can constitute one superframe. This SFS structure 200, in an exemplary embodiment, complies with the Institute of Electrical & Electronics Engineers (IEEE) 802.16e frame structure. These frames are then partitioned into sub-frames 205. The sub-frames 205 include, for example, Orthogonal Frequency Divisional Multiplexing (OFDM) symbols; it is noted that other transmission schemes can be utilized.

In an exemplary embodiment, a superframe header 207 can transmitted at the start of each superframe 201 or in any other fixed location within the superframe 201; the header 207 can include configuration information. As noted, a frame 203 includes one or more sub-frames 205. For example, in the case of MAP (media access protocol) messages, which are used to convey resource allocation information, these messages can be transmitted once for each radio frame 203, or may be transmitted in each sub-frame 205 or the 1^{st} sub-frame of a number of concatenated sub-frames 205 to enable rapid scheduling and feedback.

According to one embodiment, “sub-frame concatenation” is defined as multiple concatenated adjacent sub-frames 205. A MAP message can be transmitted in the 1^{st} sub-frame in the sub-frame concatenation. The resource allocation information of all the concatenated sub-frames will be transmitted in the MAP message.

Conventional approaches to sleep mode operations (e.g., IEEE 802.16e) cannot accommodate the SFS frame structure 200. In particular, use of this SFS frame structure 200 can be problematic. For instance, the MS 101 can miss the superframe system configuration information if the MS 101 wakes up in a new listening window. Also, the MS 101 might have to decode the MAP messages in multiple sub-frames in each frame in the listening window, which reduces the power saving efficiency. Further, the conventional approach fails to address issues relating to lengths of the sleep window and the listening window.

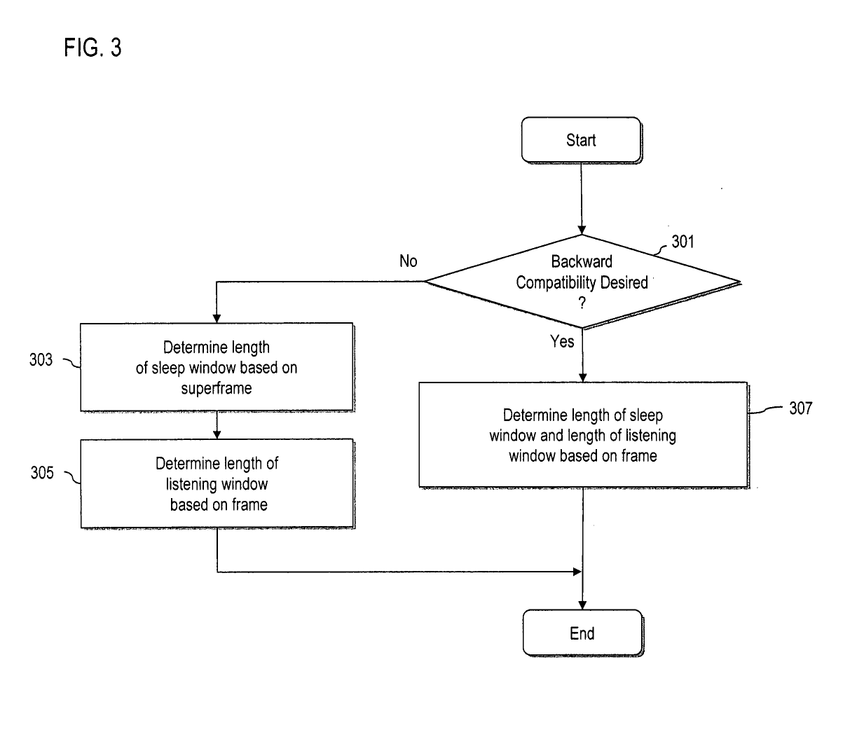

FIG. 3 is a flowchart of a process for determining lengths of a listening window and a sleep window, in accordance with an embodiment of the invention. From the above discussion, it is recognized that the determination of the lengths of the sleep window 117 and the listening window 115 poses a challenge in that it is not known whether the superframe, the frame, or the sub-frame should be utilized as the basic unit. In 802.16e, the length of sleep window 117 and listening window 115 are computed based on number of frames. A listening window 115 defines the duration in which the MS 101 is in an active mode (or awake state) of operation, whereby the MS 101 can receive traffic. Conversely, a sleep window 117 specifies the duration in which the MS 101 is inactive (or sleep mode).

Simply employing superframes or sub-frames as the basic unit for computing the windows has a number of drawbacks. Assuming one superframe contains 4 frames, the granularity of the windows can be too large, particularly for a listening window. That is, one listening window will be at least 4 frames, which means in each listening window, the MS 101 has to keep awake for at least 4 frames, which can be unnecessarily long in many cases. It is noted that the listening window is utilized mainly for the MS 101 to wake up and check whether there is new traffic that has arrived during the recent sleep window period.

Computing window lengths based on sub-frames has the drawback that control messages (e.g., MAP messages) might be not transmitted in each sub-frame (e.g., when there is sub-frame concatenation). Therefore, when the MS 101 wakes up in one sub-frame, it is possible that no MAP message is transmitted. In this case, related procedures need to be defined and developed to ensure that the BS 103 could be synchronized with the MS 101 with respect to when the information is to be transmitted to the MS 101. For example, the MS 101 has to keep awake until the next sub-frame, which includes the MAP message. Another drawback is that this approach cannot work under the scenarios in which one frame contains variable number of sub-frames and the frame/sub-frame configuration changes from frame to frame (or from superframe to superframe). As such, when the MS 101 goes to sleep for several frames/superframes, the MS 101 could lose synchronization with BS 103 in terms of sub-frame number.

In view of the above drawbacks, the process of FIG. 3 is introduced to provide an approach that can address such drawbacks and account for backward compatibility issues. According to one embodiment, backward compatibility with IEEE 802.16e systems can be achieved; IEEE 802.16e utilizes frames are the basic unit for computing the listening window and sleep window. As seen in FIG. 3, if backward compatibility is not desired (as determined in step 301), the process can determine length of the sleep window based on the number of superframes, per step 303. In step 305, the length of the listening window is determined based on the number of frames (as with IEEE 802.16e).

However, if compatibility with an older system, such as IEEE 802.16e, is to be preserved, the process merely determines the listening window length and the sleep window length using the number of frames, as in step 307.

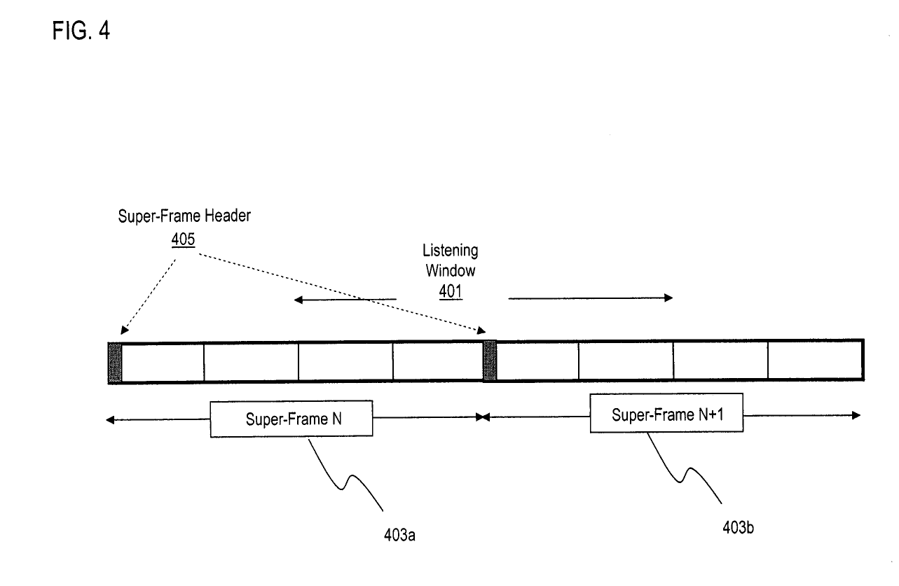

FIG. 4 is a diagram of a listening window, according to an exemplary embodiment of the invention. By way of example, a listening window 401 encompasses two superframes 403a, 403b. Each of the superframes 403a, 403b includes a header 405. As will be more fully described, the content of the header 405 can include system configuration information and/or other control information; for example, the system configuration information can include superframe number, downlink channel descriptor (DCD)/uplink channel descriptor (UCD) configuration change count, sub-frame concatenation pattern, etc. Moreover, according to one embodiment, a preamble (not shown) can be used for synchronization.

As shown, a superframe header 405 and/or synchronization preamble can be transmitted at the start of each superframe or in any other fixed location within the superframe 403. If the MS 101 cannot acquire the header 405 or preamble, the MS 101 may not be able to decode traffic properly. For instance, without sub-frame concatenation information, the MS 101 would not be notified of which sub-frames MAP messages are transmitted. This scenario can occur when the listening window overlaps with a superframe, and the overlap does not contain the superframe header 405 and/or synchronization preamble.

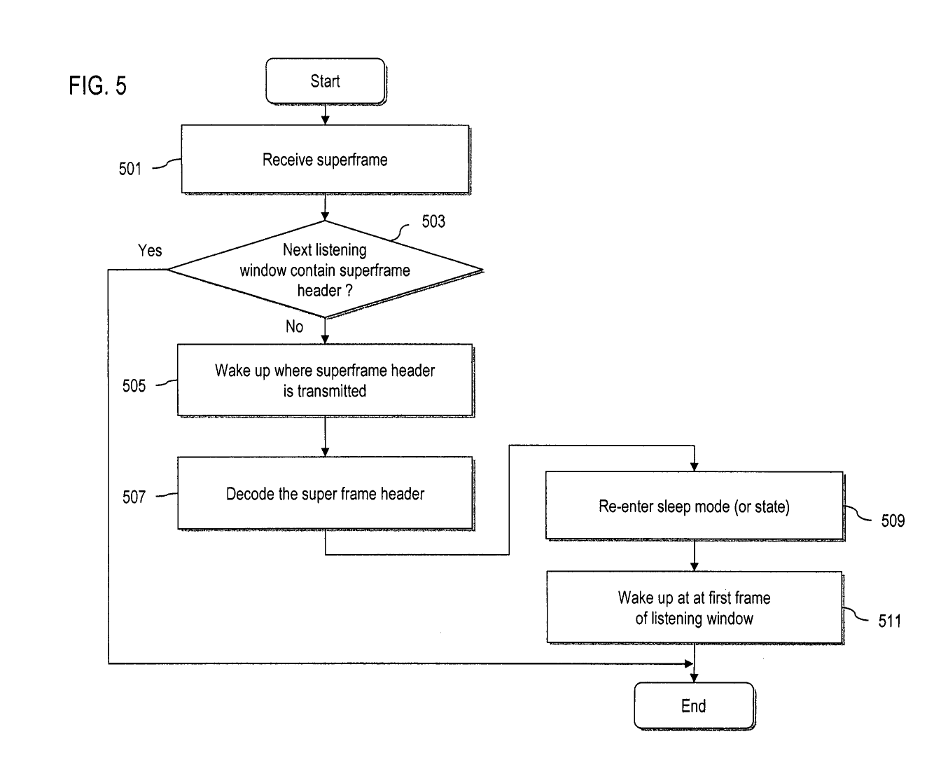

The acquisition of system configuration information and/or preamble synchronization is now described with respect to FIGS. 5-7.

FIG. 5 is a flowchart of a process for acquiring configuration information by examining the next listening window, in accordance with an embodiment of the invention. This process ensures that the MS 101 can acquire system configuration information and preamble synchronization when the MS 101 transitions from the inactive state to the active state (i.e., wakes up). In step 501, a superframe is received by the MS. The MS 101 then determines whether the next listening window contains a superframe header, as in step 503. If the MS 101 determines that the 1^{st} frame in the next listening window does not contain superframe header information (i.e., is not the 1^{st} frame of a superframe, in the case where the superframe header is transmitted in the first frame), the MS 101 first wakes up at the start of the superframe, per step 505. In general, the MS 101 wakes up at the point where the superframe header is transmitted. In step 507, the process decodes the superframe header, and then resumes the sleep mode (step 509). In step 511, the MS 101 can later wake up again at the 1^{st} frame of the listening window to obtain the system configuration information and/or preamble.

In the alternative, the MS 101 can be made to wake up at a particular frame within the superframe, as next described.

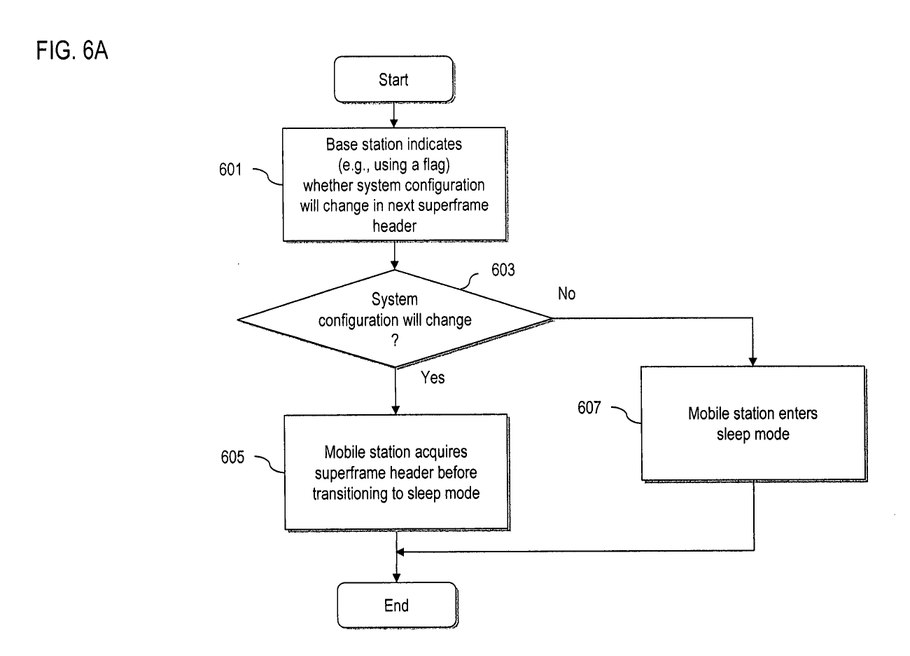

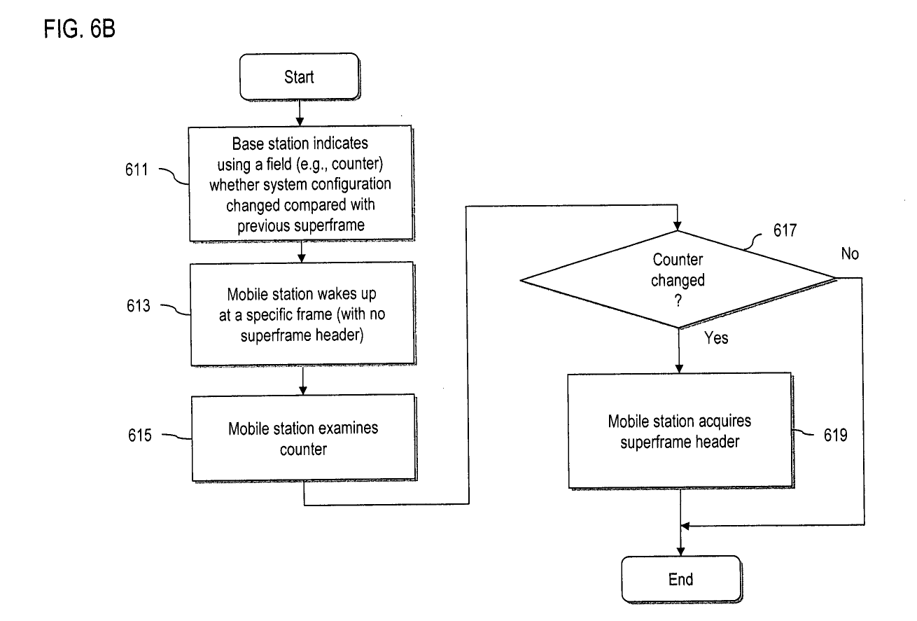

FIGS. 6A and 6B are flowcharts of processes for acquiring configuration information by waking up based on the superframe header, in accordance with an embodiment of the invention. For certain types of traffic (e.g., Voice over IP (VoIP)) whose packets arriving cycle is comparable to one superframe time—e.g. one VoIP packet per superframe time—the MS 101 is likely to wake up in the n-th frame per superframe, where n(≧0) is an integer that is less than (or equal to) the number of frames per superframe. The processes of FIGS. 6A and 6B permit the MS 101 to enter the active state only at the superframe header as necessary.

As shown in FIG. 6A, the base station 103 indicates whether the system configuration will change in the next superframe header. In an exemplary embodiment, a flag (e.g., 1-bit in length) is set accordingly; e.g., a value of “1” indicates that the system configuration will change, while a “0” indicates no change (step 601). The MS 101 examines the flag to determine whether a change will occur, as in step 603. If a change is indicated, the MS 101 tries to acquire, as in step 605, the superframe header before re-entering the sleep mode; otherwise, the MS 101 is inactive (step 607). This mechanism wakes the MS 101 up only to decode superframe header when system configuration is changed.

FIG. 6B illustrates an alternative process, whereby the base station 103 uses a field (e.g., superframe configuration counter, or S-counter) within a control message, such as a MAP message, of every frame/sub-frame to indicate to the MSs whether superframe configuration is changed as compared with a previous superframe, per step 611. In an exemplary embodiment, this field is useful if the MS 101 fails to receive a 1-bit flag (per the process of FIG. 6A), or when the sleep window spans multiple superframes (e.g., 3 superframes). In such a case, the MS 101 is not aware whether the BS 103 is going to change superframe configuration or not in the next superframe where the MS 101 wakes up. Accordingly, when the MS 101 wakes up at a specific frame (which does not contain superframe header), the MS 101 will also verify S-counter (steps 613 and 615). If the S-counter does not change (as determined in step 617), then the MS 101 will behave normally; otherwise, the MS 101 will acquire superframe header in the next superframe, as in step 619.

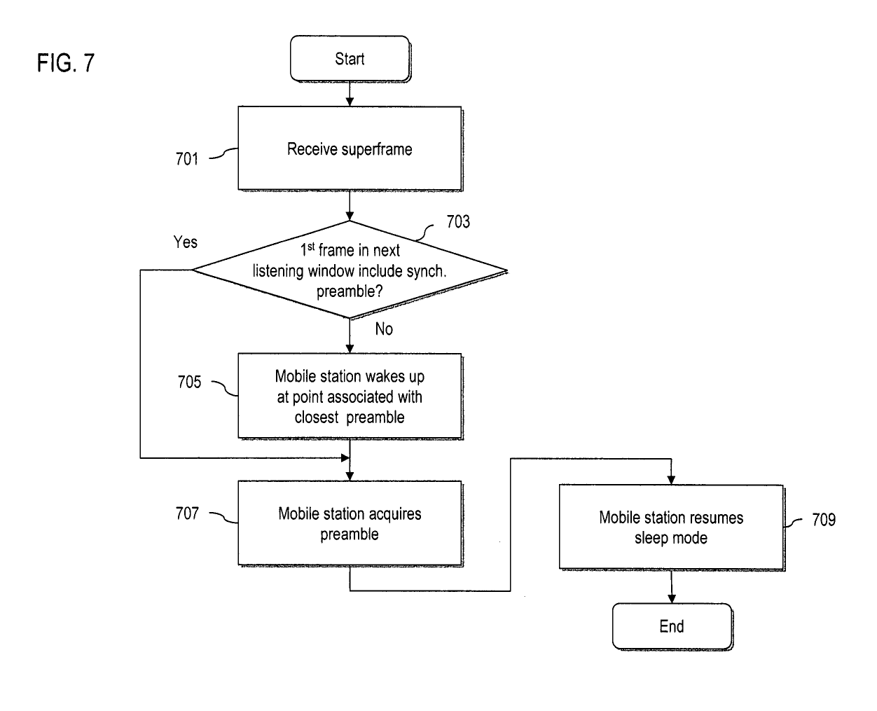

FIG. 7 is a flowchart of a process for acquiring synchronization of a superframe, in accordance with an embodiment of the invention. In this example, the MS 101 receives a superframe, as in step 701. If the MS 101 finds that the 1^{st} frame in the next listening window does not contain the synchronization preamble (per step 703), the MS 101 wakes up at the point where the closest preamble preceding the listening window is transmitted (step 705).

In step 707, the MS 101 acquires the preamble. After the preamble reception, the MS 101 resumes the sleep mode (step 709) and wakes up again when the previous rule occurs (i.e., superframe header reception) or when the scheduled listening window begins.

In certain embodiments, the superframe header and synchronization preamble are generally transmitted at the start of each superframe. When superframe is used as the unit to compute the sleep window length, MSs can readily acquire the superframe header as the MSs will wakeup at the start of the superframes.

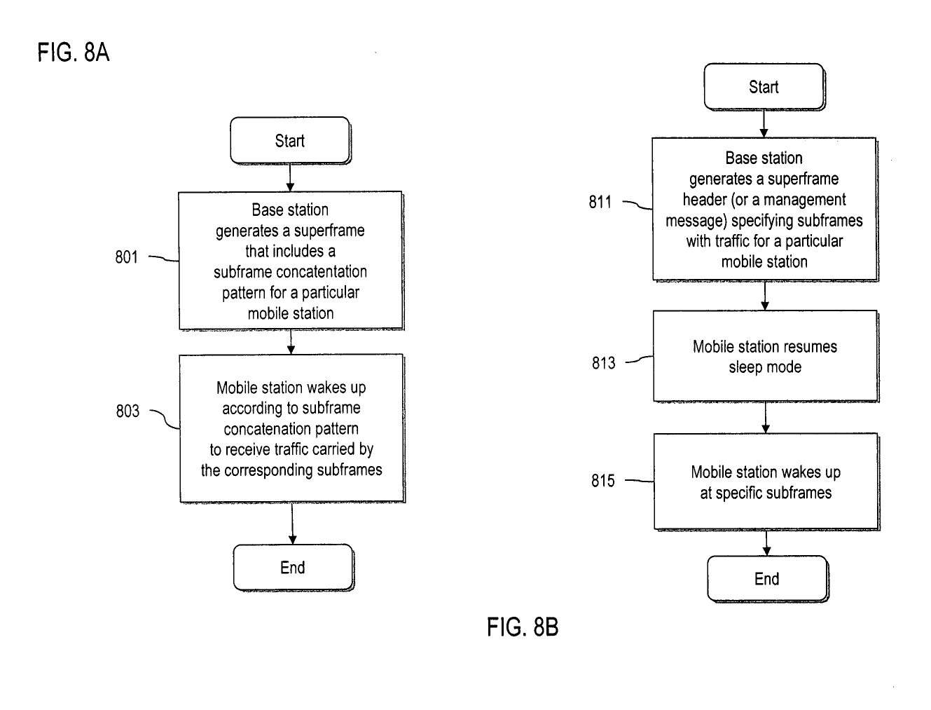

FIGS. 8A and 8B are flowcharts of processes for providing power saving based on sub-frame structure, in accordance with an embodiment of the invention. According to conventional approaches (e.g., the IEEE 802.16e specification), the MS 101 is expected to receive all downlink (DL) transmissions in the same way as in the state of normal operations (i.e., no sleep) during the listening windows. By way of example, the transmission of a MAP message is described. As such, there is one MAP message at the start of each sub-frame concatenation; that is, there could be MAP message in multiple sub-frames in a frame. Therefore, the MS 101 has to decode MAP message at the start of each sub-frame concatenation, which means the MS 101 has to wake up several time during a frame. In general, the MS 101 has to decode all the MAP messages transmitted within the radio frames where MSs is in the awake state. This is inefficient with respect to power saving. Therefore, the processes of FIGS. 8A and 8B can address such shortcoming.

Per FIG. 8A, the base station 103 can generate a superframe that includes a sub-frame concatenation pattern for a particular mobile station 101, as in step 801. In other words, the base station 103 can notify the MS 101 that the base station 103 will only transmit traffic related to the MS 101 in the n^{th} “sub-frame concatenation” during each frame in the listening window. The parameter n can be assigned by the BS during the definition of the related power saving class (PSC). According to one embodiment, a field (e.g., 3 bit in length) is defined to specify the parameter n.

Accordingly, there is no traffic for the MS 101 in the other sub-frames, while the MS 101 is in the sleep mode. It is noted that there may be exceptions whereby for some frames the total number of “sub-frame concatenation” m<n. In this case, MS 101 could select to wake up at the 1^{st} “sub-frame concatenation” or the m-th “sub-frame concatenation,” which can also determined during the definition of the PSC by the BS.

In one embodiment, the “sub-frame concatenation” pattern is defined in superframe header in a superframe-by-superframe manner. Therefore, the MS 101 can acquire such information (e.g., m) by using the processes of FIGS. 5-7. In step 803, the mobile station 101 enters the active state according to the sub-frame concatenation pattern. If the “sub-frame concatenation” pattern is changed frame-by-frame, the MS 101 can wake up at the point where the “frame header” is transmitted. The MS 101 can further decode related information in addition to waking up at the specific sub-frame concatenation.

An implementation example is provided below based on modification of MOB_SLP-RSP message, for instance.

TABLE 1

| Syntax | Size | Notes |
|---|---|---|
| MOB_SLP-RSP { | | |
| Management Message | | |
| Type = 51 | | |
| Number of Classes | 8 bits | Number of power saving classes |
| for (i= 0; i < | | |
| Number_of_Classes; | | |
| i++) { | | |
| Length of Data | 7 bits | |
| . . . | | |
| if (Definition = 1) { | | |
| . . . | | |
| Flag | 1 bit | 0 = process of FIG. 8A is not used for |
| | | this PSC |
| | | 1 = the process of FIG. 8A is used |
| . . . | | |
| } | | |
| TLV (Type Length | variable | A new TLV is defined, where the 3- |
| Value) encoded | | bit parameter “n” of all the PSCs with |
| information | | flag=1 are concatenated and given. |
| } | | |

Alternatively as shown in FIG. 8B, the base station 103 generates, as in step 811, a superframe header (or a management message) to indicate, using a pointer within the superframe header, in which sub-frame there is traffic. In one embodiment, a MAC management message specifies this information for the MS 101 or group of MSs. After the MS 101 obtains this information, MS 101 can enter the sleep mode (step 813), and wake up only in the specific sub-frame in each frame in the listening window per superframe header (step 815).

The described processes of FIGS. 3 and 5-8, according to certain embodiments, permit the use of the SFS frame structure in, for example, the IEEE 802.16 power saving scheme. Also, the superframe configuration information is not lost when the MS 101 wakes up from sleep window, so that MS 101 could decode DL traffic in the right way in listening windows. Further, the MS 101 only needs to listen to one MAP message during a frame in the listening window, even if there are MAP messages transmitted in multiple sub-frames in that frame. In this way, the power saving efficiency is improved.

One of ordinary skill in the art would recognize that the processes for providing power saving may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

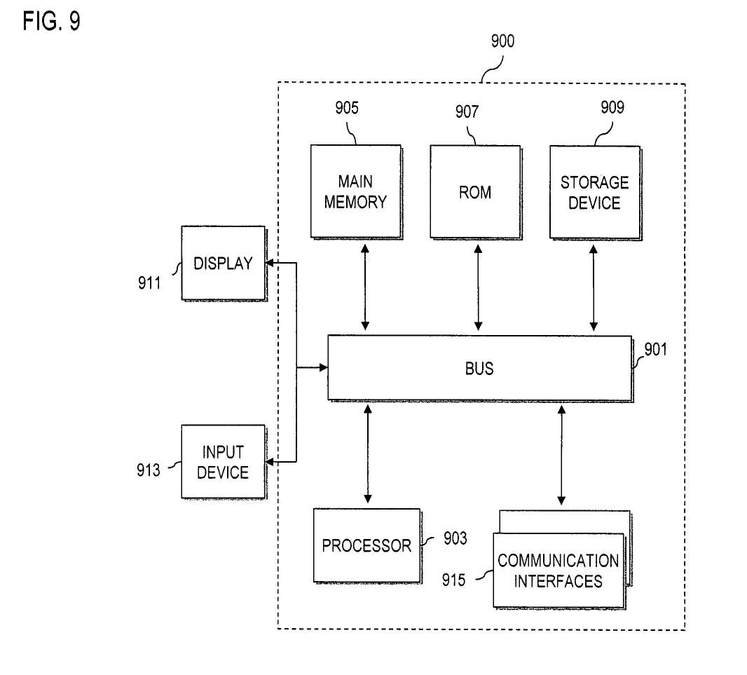

FIG. 9 illustrates exemplary hardware upon which various embodiments of the invention can be implemented. A computing system 900 includes a bus 901 or other communication mechanism for communicating information and a processor 903 coupled to the bus 901 for processing information. The computing system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computing system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computing system 900 may be coupled via the bus 901 to a display 911, such as a liquid crystal display, or active matrix display, for displaying information to a user. An input device 913, such as a keyboard including alphanumeric and other keys, may be coupled to the bus 901 for communicating information and command selections to the processor 903. The input device 913 can include a cursor control, such as a mouse, a trackball, or cursor direction keys, for communicating direction information and command selections to the processor 903 and for controlling cursor movement on the display 911.

According to various embodiments of the invention, the processes described herein can be provided by the computing system 900 in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 900 also includes at least one communication interface 915 coupled to bus 901. The communication interface 915 provides a two-way data communication coupling to a network link (not shown). The communication interface 915 sends and receives electrical, electromagnetic, or optical signals that carry digital data streams representing various types of information. Further, the communication interface 915 can include peripheral interface devices, such as a Universal Serial Bus (USB) interface, a PCMCIA (Personal Computer Memory Card International Association) interface, etc.

The processor 903 may execute the transmitted code while being received and/or store the code in the storage device 909, or other non-volatile storage for later execution. In this manner, the computing system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIGS. 10A and 10B are diagrams of an exemplary WiMAX architecture, in which the system of FIGS. 1A and 1B can operate, according to various exemplary embodiments of the invention. The architecture shown in FIGS. 10A and 10B can support fixed, nomadic, and mobile deployments and be based on an IP service model.

Subscriber or mobile stations 1001 can communicate with an access service network (ASN) 703, which includes one or more base stations 1005. In this exemplary system, the BS 103, in addition to providing the air interface to the MS 101, possesses such management functions as handoff triggering and tunnel establishment, radio resource management, quality of service (QoS) policy enforcement, traffic classification, DHCP (Dynamic Host Control Protocol) proxy, key management, session management, and multicast group management.

The base station 1005 has connectivity to an access network 1007. The access network 1007 utilizes an ASN gateway 1009 to access a connectivity service network (CSN) 1011 over, for example, a data network 1013. By way of example, the network 1013 can be a public data network, such as the global Internet.

The ASN gateway 1009 provides a Layer 2 traffic aggregation point within the ASN 1003. The ASN gateway 1009 can additionally provide intra-ASN location management and paging, radio resource management and admission control, caching of subscriber profiles and encryption keys, AAA client functionality, establishment and management of mobility tunnel with base stations, QoS and policy enforcement, foreign agent functionality for mobile IP, and routing to the selected CSN 1011.

The CSN 1011 interfaces with various systems, such as application service provider (ASP) 1015, a public switched telephone network (PSTN) 1017, and a Third Generation Partnership Project (3GPP)/3GPP2 system 1019, and enterprise networks (not shown).

The CSN 1011 can include the following components: Access, Authorization and Accounting system (AAA) 1021, a mobile IP-Home Agent (MIP-HA) 1023, an operation support system (OSS)/business support system (BSS) 1025, and a gateway 1027. The AAA system 1021, which can be implemented as one or more servers, provide support authentication for the devices, users, and specific services. The CSN 1011 also provides per user policy management of QoS and security, as well as IP address management, support for roaming between different network service providers (NSPs), location management among ASNs.

FIG. 10B shows a reference architecture that defines interfaces (i.e., reference points) between functional entities capable of supporting various embodiments of the invention. The WiMAX network reference model defines reference points: R1, R2, R3, R4, and R5. R1 is defined between the MS 101 and the ASN 1003a; this interface, in addition to the air interface, includes protocols in the management plane. R2 is provided between the MS 101 and an CSN (e.g., CSN 1011a and 1011b) for authentication, service authorization, IP configuration, and mobility management. The ASN 1003a and CSN 1011a communicate over R3, which supports policy enforcement and mobility management.

R4 is defined between ASNs 1003a and 1003b to support inter-ASN mobility. R5 is defined to support roaming across multiple NSPs (e.g., visited NSP 1029a and home NSP 1029b).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1.-27. (canceled)

28. A method comprising:
detecting a superframe that includes a plurality of frames, wherein each of the frames is partitioned into sub-frames;
determining length of a listening window based on the number of frames; and
determining length of a sleep window based on the superframe, wherein the sleep window length specifies duration of an inactive mode of operation, and the listening window specifies duration of an active mode of operation.

29. A method according to claim 28, wherein the length of the sleep window is alternatively determined based on the number of frames for backward compatibility.

30. A method according to claim 28, further comprising:
acquiring configuration information from a header of the superframe; and
acquiring synchronization based on a preamble of the superframe.

31. A method according to claim 30, wherein the step of acquiring configuration information includes:
determining whether, during a next listening window, the header is received;
decoding the header if the header is received; and
entering the inactive mode of operation.

32. A method according to claim 30, wherein the step of acquiring configuration information includes:
determining whether the configuration information is changed, wherein new configuration information is acquired before entering the inactive mode of operation.

33. A method according to claim 28, further comprising:
receiving information, within a header of the superframe, specifying a particular sub-frame carrying traffic during each frame of the listening window.

34. A method according to claim 28, further comprising:
receiving a management message specifying a particular sub-frame carrying traffic within each frame within the listening window.

35. A computer-readable storage medium carrying one or more sequences of one or more instructions which, when executed by one or more processors, cause the one or more processors to perform the method of claim 28.

36. An apparatus comprising:
logic configured to detect a superframe that includes a plurality of frames, wherein each of the frames is partitioned into sub-frames,
wherein the logic is further configured to determine length of a listening window based on the number of frames, and to determine length of a sleep window based on the superframe,
wherein the sleep window length specifies duration of an inactive mode of operation, and the listening window specifies duration of an active mode of operation.

37. An apparatus according to claim 36, wherein the length of the sleep window is alternatively determined based on the number of frames for backward compatibility.

38. An apparatus according to claim 36, wherein the logic is further configured to acquire configuration information from a header of the superframe, and to acquire synchronization based on a preamble of the superframe.

39. An apparatus according to claim 38, wherein the logic is further configured to determine whether, during a next listening window, the header is received, to decode the header if the header is received, and to enter the inactive mode of operation.

40. An apparatus according to claim 38, wherein the logic is further configured to determine whether the configuration information is changed, wherein new configuration information is acquired before entering the inactive mode of operation.

41. An apparatus according to claim 36, wherein the logic is further configured to receive information, within a header of the superframe, specifying a particular sub-frame carrying traffic during each frame of the listening window.

42. An apparatus according to claim 36, wherein the logic is further configured to receive a management message specifying a particular sub-frame carrying traffic within each frame within the listening window.

43. A method comprising:
generating a superframe that includes a plurality of frames, wherein each of the frames is partitioned into sub-frames,
wherein the superframe includes a sub-frame concatenation pattern relating to an awake state of terminal operation.

44. A method according to claim 43, wherein sub-frame concatenation pattern is defined in a header of the superframe.

45. A method according to claim 43, further comprising:
modifying the sub-frame concatenation pattern on a frame-by-frame basis.

46. A computer-readable storage medium carrying one or more sequences of one or more instructions which, when executed by one or more processors, cause the one or more processors to perform the method of claim 43.
